(19) United States
(12) Patent Application Publication
(10) Pub. No.: US 2024/0336732 A1
(43) Pub. Date: Oct. 10, 2024

(54) METHOD FOR PREPARING SURFACTANTS BY COPOLYMERISATION OF EPOXIDES AND CO2 USING A MIXTURE OF A MACROCYCLIC BIMETAL CATALYST AND A DOUBLE METAL CYANIDE CATALYST

(71) Applicant: Econic Technologies Ltd., Macclesfield, Cheshire (GB)

(72) Inventors: James LEELAND, Macclesfield, Cheshire (GB); Michael Kember, Macclesfield, Cheshire (GB)

(21) Appl. No.: 18/294,312

(22) PCT Filed: Aug. 11, 2022
(86) PCT No.: PCT/GB2022/052102

§ 371 Date: Feb. 1, 2024

(30) Foreign Application Priority Data
Aug. 11, 2021 (GB) 2111555.5

(51) Int. Cl. C08G 64/34; C08G 64/02; C08G 65/26; C11D 1/722

(52) U.S. Cl. CPC C08G 64/34; C08G 64/0208; C08G 65/2603; C08G 65/2663; C08G 65/269; C11D 1/722

(57) ABSTRACT

Catayltic methods for preparing surfactant molecules, surfactant molecules obtainable by the method, compositions comprising the surfactant molecules, and to the use of surfactant molecules so prepared in cleaning products. The method comprises reacting carbon dioxide and an epoxide in the presence of a double metal cyanide (DMC) catalyst, a catalyst of formula (I), and a monofunctional starter compound,

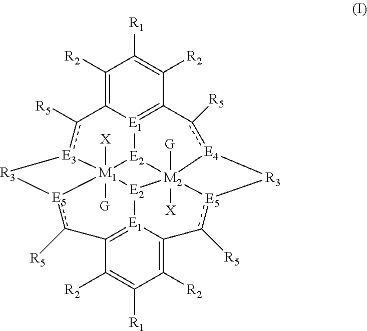

### TECHNICAL FIELD

The present invention relates to surfactant molecules, to catalytic methods for preparing surfactant molecules, and to the use of surfactant molecules so prepared. The present invention relates more particularly, but not necessarily exclusively, to methods having improved specificity through controlled addition of materials during polymerisation.

### BACKGROUND

Surfactants are compounds that typically lower the tension between two liquid phases. Typically, surfactants used in aqueous systems comprise hydrophobic and hydrophilic groups and are described as amphiphilic.

Traditionally the hydrophobic portion of non-ionic surfactants comprises a hydrocarbon chain, which is either derived from petroleum or natural oils, such as palm oil, and a polyether chain, which is derived from petroleum. It is therefore desirable to form surfactants from alternative feedstocks, in particular more sustainable feedstocks.

It would be advantageous to produce water soluble surfactant molecules for use in cleaning systems that use carbon dioxide as a renewable raw material but under moderate pressures that can operate in existing manufacturing equipment. It would also be advantageous to produce them in a one-pot reaction without multiple reaction stages.

It is an object of the present invention to provide a process to produce a CO₂ containing surfactant molecule at moderate pressures using a two catalyst system.

### SUMMARY OF THE INVENTION

According to the invention, there is provided a method for preparing a surfactant molecule, the method comprising reacting carbon dioxide and an epoxide in the presence of a double metal cyanide (DMC) catalyst, a catalyst of formula (I), and a monofunctional starter compound, wherein the catalyst of formula (I) has the following structure:

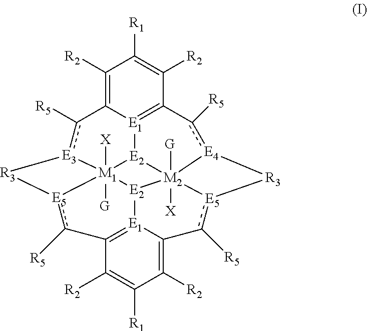

wherein M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(II), Al(III)-X, Ti(III)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl; E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] , and wherein when E₃, E₄, E₅, or E₆ are NR₄, O or S, [symbol] is, [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)Rₓ, OSO₂Rₓ, OSORₓ, OSO(Rₓ)₂, S(O)Rₓ, ORₓ, phosphinate, halide, nitrate, hydroxyl, carbonate, amino, amido or optionally substituted aliphatic, heteroaliphatic, alicyclic, heteroalicyclic, aryl or heteroaryl, wherein each X may be the same or different and wherein X may form a bridge between M₁ and M₂;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base.

The method may comprise forming a mixture comprising monofunctional starter compound, epoxide, carbon dioxide, catalyst of formula (I), double metal cyanide (DMC) catalyst and optionally solvent, and subsequently increasing the temperature by at least 10° C.

The method may comprise the steps of:
(I) (a) mixing catalyst of formula (I), double metal cyanide (DMC) catalyst and optionally carbon dioxide and/or solvent with epoxide and optionally monofunctional starter compound and/or carbon dioxide to form mixture (α); or
   (b) mixing double metal cyanide (DMC) catalyst and optionally monofunctional starter compound, carbon dioxide and/or solvent with epoxide and optionally carbon dioxide and/or solvent to form mixture (α); or
   (c) mixing epoxide, catalyst of formula (I), monofunctional starter compound and carbon dioxide and optionally solvent to form mixture (α); or
   (d) mixing catalyst of formula (I), double metal cyanide (DMC) catalyst and optionally monofunctional starter compound, epoxide, carbon dioxide and/or solvent to form mixture (α); and
(II) adding one or more of monofunctional starter compound, epoxide, carbon dioxide, catalyst of formula (I), double metal cyanide (DMC) catalyst and/or solvent to mixture (α) to form mixture (β) comprising monofunctional starter compound, epoxide, carbon dioxide, catalyst of formula (I), double metal cyanide (DMC) catalyst and optionally solvent, and/or increasing the temperature by 10° C.

There is also provided a surfactant molecule obtainable by the methods described herein, use of said surfactant molecule in a cleaning product and a composition comprising said surfactant molecule wherein the composition is a surfactant formulation for a cleaning product.

The surfactant molecule of the invention may also be used as a functional additive in agrichemicals, enhanced oil recovery, construction materials in the nature of foams, coatings, paints, adhesives, automotive applications, and textile manufacture. Suitable compositions for use in such applications may be formulated comprising the surfactant molecule of the invention.

### DEFINITIONS

For the purpose of the present invention, an aliphatic group is a hydrocarbon moiety that may be straight chain (i.e. unbranched) branched, or cyclic and may be completely saturated, or contain one or more units of unsaturation, but which is not aromatic. The term “unsaturated” means a moiety that has one or more double and/or triple bonds. The term “aliphatic” is therefore intended to encompass alkyl, cycloalkyl, alkenyl cycloalkenyl, alkynyl or cycloalkenyl groups, and combinations thereof.

An aliphatic group is optionally a C₁₋₃₀ aliphatic group, that is, an aliphatic group with 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 carbon atoms. Optionally, an aliphatic group is a C₁₋₁₅aliphatic, optionally a C₁₋₁₂aliphatic, optionally a C₁₋₁₀aliphatic, optionally a C₁₋₈aliphatic, such as a C₁₋₆aliphatic group. Suitable aliphatic groups include linear or branched, alkyl, alkenyl and alkynyl groups, and mixtures thereof such as (cycloalkyl) alkyl groups, (cycloalkenyl) alkyl groups and (cycloalkyl) alkenyl groups.

The term “alkyl,” as used herein, refers to saturated, straight-or branched-chain hydrocarbon radicals derived by removal of a single hydrogen atom from an aliphatic moiety. An alkyl group is optionally a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Optionally, an alkyl group is a C₁₋₁₅ alkyl, optionally a C₁₋₁₂ alkyl, optionally a C₁₋₁₀ alkyl, optionally a C₁₋₈ alkyl, optionally a C₁₋₆ alkyl group. Specifically, examples of “C₁₋₂₀ alkyl group” include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like.

The term “alkenyl,” as used herein, denotes a group derived from the removal of a single hydrogen atom from a straight-or branched-chain aliphatic moiety having at least one carbon-carbon double bond. The term “alkynyl,” as used herein, refers to a group derived from the removal of a single hydrogen atom from a straight-or branched-chain aliphatic moiety having at least one carbon-carbon triple bond. Alkenyl and alkynyl groups are optionally “C₂₋₂₀alkenyl” and “C₂₋₂₀alkynyl”, optionally “C₂₋₁₅ alkenyl” and “C₂₋₁₅ alkynyl”, optionally “C₂₋₁₂ alkenyl” and “C₂₋₁₂ alkynyl”, optionally “C₂₋₁₀ alkenyl” and “C₂₋₁₀ alkynyl”, optionally “C₂₋₈ alkenyl” and “C₂₋₈ alkynyl”, optionally “C₂₋₆ alkenyl” and “C₂₋₆ alkynyl” groups, respectively. Examples of alkenyl groups include ethenyl, propenyl, allyl, 1,3-butadienyl, butenyl, 1-methyl-2-buten-1-yl, allyl, 1,3-butadienyl and allenyl. Examples of alkynyl groups include ethynyl, 2-propynyl (propargyl) and 1-propynyl.

The terms “cycloaliphatic”, “carbocycle”, or “carbocyclic” as used herein refer to a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The terms “cycloaliphatic”, “carbocycle” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group may comprise an alicyclic ring bearing one or more linking or non-linking alkyl substituents, such as —CH₂-cyclohexyl. Specifically, examples of carbocycles include cyclopropane, cyclobutane, cyclopentane, cyclohexane, bicycle [2,2,1]heptane, norborene, phenyl, cyclohexene, naphthalene, spiro [4.5]decane, cycloheptane, adamantane and cyclooctane.

A heteroaliphatic group (including heteroalkyl, heteroalkenyl and heteroalkynyl) is an aliphatic group as described above, which additionally contains one or more heteroatoms. Heteroaliphatic groups therefore optionally contain from 2 to 21 atoms, optionally from 2 to 16 atoms, optionally from 2 to 13 atoms, optionally from 2 to 11 atoms, optionally from 2 to 9 atoms, optionally from 2 to 7 atoms, wherein at least one atom is a carbon atom. Optional heteroatoms are selected from O, S, N, P and Si. When heteroaliphatic groups have two or more heteroatoms, the heteroatoms may be the same or different. Heteroaliphatic groups may be substituted or unsubstituted, branched or unbranched, cyclic or acyclic, and include saturated, unsaturated or partially unsaturated groups.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Optionally, an alicyclic group has from 3 to 15, optionally from 3 to 12, optionally from 3 to 10, optionally from 3 to 8 carbon atoms, optionally from 3 to 6 carbons atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of the C₃₋₂₀ cycloalkyl group include cyclopropyl, cyclobutyl, cyclopentyl, cyclohexyl, cycloheptyl, adamantyl and cyclooctyl.

A heteroalicyclic group is an alicyclic group as defined above which has, in addition to carbon atoms, one or more ring heteroatoms, which are optionally selected from O, S, N, P and Si. Heteroalicyclic groups optionally contain from one to four heteroatoms, which may be the same or different. Heteroalicyclic groups optionally contain from 5 to 20 atoms, optionally from 5 to 14 atoms, optionally from 5 to 12 atoms.

An aryl group or aryl ring is a monocyclic or polycyclic ring system having from 5 to 20 carbon atoms, wherein at least one ring in the system is aromatic and wherein each ring in the system contains three to twelve ring members. The term “aryl” can be used alone or as part of a larger moiety as in “aralkyl”, “aralkoxy”, or “aryloxyalkyl”. An aryl group is optionally a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, anthracyl group, naphthyl group or azulenyl group and the like. It should be noted that condensed rings such as indan, benzofuran, phthalimide, phenanthridine and tetrahydro naphthalene are also included in the aryl group.

The term “heteroaryl” used alone or as part of another term (such as “heteroaralkyl”, or “heteroaralkoxy”) refers to groups having 5 to 14 ring atoms, optionally 5, 6, or 9 ring atoms; having 6, 10, or 14 π electrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of nitrogen. The term “heteroaryl” also includes groups in which a heteroaryl ring is fused to one or more aryl, cycloaliphatic, or heterocyclyl rings, where the radical or point of attachment is on the heteroaromatic ring. Examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido [2,3-b]-1,4-oxazin-3 (4H)-one. Thus, a heteroaryl group may be mono-or polycyclic.

The term “heteroaralkyl” refers to an alkyl group substituted by a heteroaryl, wherein the alkyl and heteroaryl portions independently are optionally substituted.

As used herein, the terms “heterocycle”, “heterocyclyl”, “heterocyclic radical”, and “heterocyclic ring” are used interchangeably and refer to a stable 5-to 7-membered monocyclic or 7-14-membered bicyclic heterocyclic moiety that is saturated, partially unsaturated, or aromatic and having, in addition to carbon atoms, one or more, optionally one to four, heteroatoms, as defined above. When used in reference to a ring atom of a heterocycle, the term “nitrogen” includes a substituted nitrogen.

Examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, imidazolidine, indole, indoline, indolizine, indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

The term “halide”, “halo” and “halogen” are used interchangeably and, as used herein mean a fluorine atom, a chlorine atom, a bromine atom, an iodine atom and the like, optionally a fluorine atom, a bromine atom or a chlorine atom, and optionally a fluorine atom.

A haloalkyl group is optionally a “C₁₋₂₀ haloalkyl group”, optionally a “C₁₋₁₅ haloalkyl group”, optionally a “C₁₋₁₂ haloalkyl group”, optionally a “C₁₋₁₀ haloalkyl group”, optionally a “C₁₋₈ haloalkyl group”, optionally a “C₁₋₆ haloalkyl group” and is a C₁₋₂₀ alkyl, a C₁₋₁₅ alkyl, a C₁₋₁₂ alkyl, a C₁₋₁₀ alkyl, a C₁₋₈ alkyl, or a C₁₋₆ alkyl group, respectively, as described above substituted with at least one halogen atom, optionally 1, 2 or 3 halogen atom(s). The term “haloalkyl” encompasses fluorinated or chlorinated groups, including perfluorinated compounds. Specifically, examples of “C₁₋₂₀ haloalkyl group” include fluoromethyl group, difluoromethyl group, trifluoromethyl group, fluoroethyl group, difluroethyl group, trifluoroethyl group, chloromethyl group, bromomethyl group, iodomethyl group and the like.

An alkoxy group is optionally a “C₁₋₂₀ alkoxy group”, optionally a “C₁₋₁₅ alkoxy group”, optionally a “C₁₋₁₂ alkoxy group”, optionally a “C₁₋₁₀ alkoxy group”, optionally a “C₁₋₈ alkoxy group”, optionally a “C₁₋₆ alkoxy group” and is an oxy group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively. Specifically, examples of “C₁₋₂₀ alkoxy group” include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1,1-dimethylpropoxy group, 1,2-dimethylpropoxy group, 2,2-dimethylpropoxy group, 2-methylbutoxy group, 1-ethyl-2-methylpropoxy group, 1,1,2-trimethylpropoxy group, 1,1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group and the like.

An aryloxy group is optionally a “C₅₋₂₀ aryloxy group”, optionally a “C₆₋₁₂ aryloxy group”, optionally a “C₆₋₁₀ aryloxy group” and is an oxy group that is bonded to the previously defined C₅₋₂₀ aryl, C₆₋₁₂ aryl, or C₆₋₁₀ aryl group respectively.

An alkylthio group is optionally a “C₁₋₂₀ alkylthio group”, optionally a “C₁₋₁₅ alkylthio group”, optionally a “C₁₋₁₂ alkylthio group”, optionally a “C₁₋₁₀ alkylthio group”, optionally a “C₁₋₈ alkylthio group”, optionally a “C₁₋₆ alkylthio group” and is a thio (—S—) group that is bonded to the previously defined C₁₋₂₀ alkyl, C₁₋₁₅ alkyl, C₁₋₁₂ alkyl, C₁₋₁₀ alkyl, C₁₋₈ alkyl, or C₁₋₆ alkyl group respectively.

An arylthio group is optionally a “C₅₋₂₀ arylthio group”, optionally a “C₆₋₁₂ arylthio group”, optionally a “C₆₋₁₀ arylthio group” and is a thio (—S—) group that is bonded to the previously defined C₅₋₂₀ aryl, C₆₋₁₂ aryl, or C₆₋₁₀ aryl group respectively.

An alkylaryl group is optionally a “C₆₋₁₂ aryl C₁₋₂₀ alkyl group”, optionally a a “C₆₋₁₂ aryl C₁₋₁₆ alkyl group”, optionally a “C₆₋₁₂ aryl C₁₋₆ alkyl group” and is an aryl group as defined above bonded at any position to an alkyl group as defined above. The point of attachment of the alkylaryl group to a molecule may be via the alkyl portion and thus, optionally, the alkylaryl group is —CH₂—Ph or —CH₂CH₂—Ph. An alkylaryl group can also be referred to as “aralkyl”.

A silyl group is optionally —Si(Rₛ)₃, wherein each Rₛ can be independently an aliphatic, heteroaliphatic, alicyclic, heteroalicyclic, aryl or heteroaryl group as defined above. Optionally, each Rₛ is independently an unsubstituted aliphatic, alicyclic or aryl. Optionally, each Rₛ is an alkyl group selected from methyl, ethyl or propyl.

A silyl ether group is optionally a group OSi(R₆)₃ wherein each R₆ can be independently an aliphatic, heteroaliphatic, alicyclic, heteroalicyclic, aryl or heteroaryl group as defined above. Each R₆ can be independently an unsubstituted aliphatic, alicyclic or aryl. Optionally, each R₆ is an optionally substituted phenyl or optionally substituted alkyl group selected from methyl, ethyl, propyl or butyl (such as n-butyl (nBu) or tert-butyl (tBu)). Exemplary silyl ether groups include OSi(Me)₃, OSi(Et)₃, OSi(Ph)₃, OSi(Me)₂(tBu), OSi(tBu)₃ and OSi(Ph)₂(tBu).

A nitrile group (also referred to as a cyano group) is a group CN.

An imine group is a group —CRNR, optionally—CHNR₇ wherein R₇ is an aliphatic, heteroaliphatic, alicyclic, heteroalicyclic, aryl or heteroaryl group as defined above. R₇ may be unsubstituted aliphatic, alicyclic or aryl. Optionally R₇ is an alkyl group selected from methyl, ethyl or propyl.

An acetylide group contains a triple bond —C≡C—R_{9,}optionally wherein R₉ can be hydrogen, an aliphatic, heteroaliphatic, alicyclic, heteroalicyclic, aryl or heteroaryl group as defined above. For the purposes of the invention when R₉ is alkyl, the triple bond can be present at any position along the alkyl chain. R₉ may be unsubstituted aliphatic, alicyclic or aryl. Optionally R₉ is methyl, ethyl, propyl or phenyl.

An amino group is optionally —NH₂, —NHR₁₀ or —N(R₁₀)₂ wherein R₁₀ can be an aliphatic, heteroaliphatic, alicyclic, heteroalicyclic, a silyl group, aryl or heteroaryl group as defined above. It will be appreciated that when the amino group is N(R₁₀)₂, each R₁₀ group can be the same or different. Each R₁₀ may independently an unsubstituted aliphatic, alicyclic, silyl or aryl. Optionally R₁₀ is methyl, ethyl, propyl, SiMe₃ or phenyl.

An amido group is optionally —NR₁₁C(O)— or —C(O)—NR₁₁— wherein R₁₁ can be hydrogen, an aliphatic, heteroaliphatic, alicyclic, heteroalicyclic, aryl or heteroaryl group as defined above. R₁₁ may be unsubstituted aliphatic, alicyclic or aryl. Optionally R₁₁ is hydrogen, methyl, ethyl, propyl or phenyl. The amido group may be terminated by hydrogen, an aliphatic, heteroaliphatic, alicyclic, heteroalicyclic, aryl or heteroaryl group.

An ester group is optionally —OC(O)R₁₂— or —C(O)OR₁₂— wherein R₁₂ can be an aliphatic, heteroaliphatic, alicyclic, heteroalicyclic, aryl or heteroaryl group as defined above. R₁₂ may be unsubstituted aliphatic, alicyclic or aryl. Optionally R₁₂ is methyl, ethyl, propyl or phenyl. The ester group may be terminated by an aliphatic, heteroaliphatic, alicyclic, heteroalicyclic, aryl or heteroaryl group. It will be appreciated that if R₁₂ is hydrogen, then the group defined by —OC(O)R₁₂— or —C(O)OR₁₂— will be a carboxylic acid group.

A sulfoxide is optionally —S(O)R₁₃ and a sulfonyl group is optionally —S(O)₂R₁₃ wherein R₁₃ can be an aliphatic, heteroaliphatic, alicyclic, heteroalicyclic, aryl or heteroaryl group as defined above. R₁₃ may be unsubstituted aliphatic, alicyclic or aryl. Optionally R₁₃ is methyl, ethyl, propyl or phenyl.

A carboxylate group is optionally —OC(O)R₁₄, wherein R₁₄ can be hydrogen, an aliphatic, heteroaliphatic, alicyclic, heteroalicyclic, aryl or heteroaryl group as defined above. R₁₄ may be unsubstituted aliphatic, alicyclic or aryl. Optionally R₁₄ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

A phosphinate group is optionally —OP(O)(R₁₆)₂ or —P(O)(OR₁₆)(R₁₆) wherein each R₁₆ is independently selected from hydrogen, or an aliphatic, heteroaliphatic, alicyclic, heteroalicyclic, aryl or heteroaryl group as defined above. R₁₆ may be aliphatic, alicyclic or aryl, which are optionally substituted by aliphatic, alicyclic, aryl or C₁₋₆alkoxy. Optionally R₁₆ is optionally substituted aryl or C₁₋₂₀ alkyl, optionally phenyl optionally substituted by C₁₋₆alkoxy (optionally methoxy) or unsubstituted C₁₋₂₀alkyl (such as hexyl, octyl, decyl, dodecyl, tetradecyl, hexadecyl, stearyl). A phosphonate group is optionally —P(O)(OR₁₆)₂ wherein R₁₆ is as defined above. It will be appreciated that when either or both of R₁₆ is hydrogen for the group —P(O)(OR₁₆)₂, then the group defined by —P(O)(OR₁₆)₂ will be a phosphonic acid group.

A sulfinate group is optionally —S(O)OR₁₇ or —OS(O)R₁₇ wherein R₁₇ can be hydrogen, an aliphatic, heteroaliphatic, haloaliphatic, alicyclic, heteroalicyclic, aryl or heteroaryl group as defined above. R₁₇ may be unsubstituted aliphatic, alicyclic or aryl. Optionally R₁₇ is hydrogen, methyl, ethyl, propyl or phenyl. It will be appreciated that if R₁₇ is hydrogen, then the group defined by —S(O)OR₁₇ will be a sulfonic acid group.

A carbonate group is optionally —OC(O)OR₁₈, wherein R₁₈ can be hydrogen, an aliphatic, heteroaliphatic, alicyclic, heteroalicyclic, aryl or heteroaryl group as defined above. R₁₈ may be optionally substituted aliphatic, alicyclic or aryl. Optionally R₁₈ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. It will be appreciated that if R₁₇ is hydrogen, then the group defined by —OC(O)OR₁₈ will be a carbonic acid group.

In an -alkylC(O)OR₁₉ or-alkyIC(O)R₁₉ group, R₁₉ can be hydrogen, an aliphatic, heteroaliphatic, alicyclic, heteroalicyclic, aryl or heteroaryl group as defined above. R₁₉ may be unsubstituted aliphatic, alicyclic or aryl. Optionally R₁₉ is hydrogen, methyl, ethyl, propyl, butyl (for example n-butyl, isobutyl or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl.

It will be appreciated that where any of the above groups are present in a Lewis base G, one or more additional R groups may be present, as appropriate, to complete the valency. For example, in the context of an amino group, an additional R group may be present to give RNHR₁₀, wherein R is hydrogen, an optionally substituted aliphatic, heteroaliphatic, alicyclic, heteroalicyclic, aryl or heteroaryl group as defined above. Optionally, R is hydrogen or aliphatic, alicyclic or aryl.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are optionally those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

It will be appreciated that although in formula (I), the groups X and G are illustrated as being associated with a single M₁ or M₂ metal centre, one or more X and G groups may form a bridge between the M₁ and M₂ metal centres.

For the purposes of the present invention, the epoxide substrate is not limited. The term epoxide therefore relates to any compound comprising an epoxide moiety (i.e. a substituted or unsubstituted oxirane compound). Substituted oxiranes include monosubstituted oxiranes, disubstituted oxiranes, trisubstituted oxiranes, and tetrasubstituted oxiranes. Epoxides may comprise a single oxirane moiety. Epoxides may comprise two or more oxirane moieties.

Examples of epoxides which may be used in the present invention include, but are not limited to, cyclohexene oxide, styrene oxide, ethylene oxide, propylene oxide, butylene oxide, substituted cyclohexene oxides (such as limonene oxide, C₁₀H₁₆O or 2-(3,4-epoxycyclohexyl) ethyltrimethoxysilane, C₁₁H₂₂O), alkylene oxides (such as ethylene oxide and substituted ethylene oxides), unsubstituted or substituted oxiranes (such as oxirane, epichlorohydrin, 2-(2-methoxyethoxy) methyl oxirane (MEMO), 2-(2-(2-methoxyethoxy) ethoxy) methyl oxirane (ME2MO), 2-(2-(2-(2-methoxyethoxy) ethoxy) ethoxy) methyl oxirane (ME3MO), 1,2-epoxybutane, glycidyl ethers, vinyl-cyclohexene oxide, 3-phenyl-1,2-epoxypropane, 1,2-and 2,3-epoxybutane, isobutylene oxide, cyclopentene oxide, 2,3-epoxy-1,2,3,4-tetrahydronaphthalene, indene oxide, and functionalized 3,5-dioxaepoxides. Examples of functionalized 3,5-dioxaepoxides include:

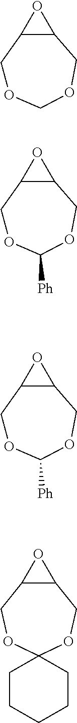

The epoxide moiety may be a glycidyl ether, glycidyl ester or glycidyl carbonate. Examples of glycidyl ethers, glycidyl esters glycidyl carbonates include:

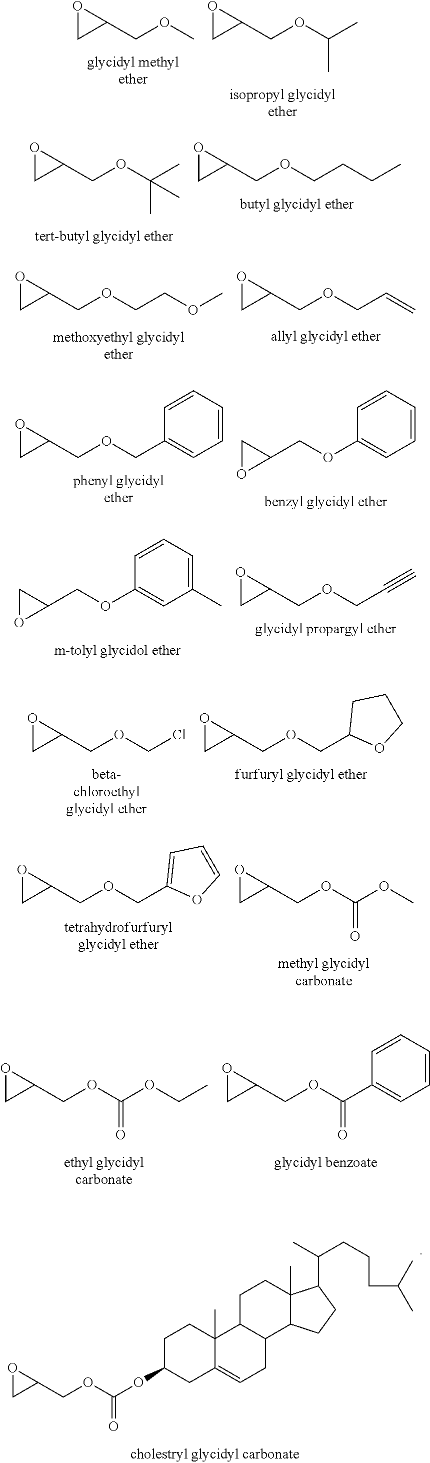

As noted above, the epoxide substrate may contain more than one epoxide moiety, i.e. it may be a bis-epoxide, a tris-epoxide, or a multi-epoxide containing moiety. Examples of compounds including more than one epoxide moiety include bisphenol A diglycidyl ether and 3,4-epoxycyclohexylmethyl 3,4-epoxycyclohexanecarboxylate. It will be understood that reactions carried out in the presence of one or more compounds having more than one epoxide moiety may lead to cross-linking in the resulting polymer.

The skilled person will appreciate that the epoxide can be obtained from “green” or renewable resources. The epoxide may be obtained from a (poly) unsaturated compound, such as those deriving from a fatty acid and/or terpene, obtained using standard oxidation chemistries.

The epoxide moiety may contain —OH moieties, or protected —OH moieties. The —OH moieties may be protected by any suitable protecting group. Suitable protecting groups include methyl or other alkyl groups, benzyl, allyl, tert-butyl, tetrahydropyranyl (THP), methoxymethyl (MOM), acetyl (C(O)alkyl), benzolyl (C(O)Ph), dimethoxytrityl (DMT), methoxyethoxymethyl (MEM), p-methoxybenzyl (PMB), trityl, silyl (such as trimethylsilyl (TMS), t-butyldimethylsilyl (TBDMS), t-butyldiphenylsilyl (TBDPS), tri-iso-propylsilyloxymethyl (TOM), and triisopropylsilyl (TIPS)), (4-methoxyphenyl) diphenylmethyl (MMT), tetrahydrofuranyl (THF), and tetrahydropyranyl (THP). The epoxide optionally has a purity of at least 98%, optionally >99%. It will be understood that the term “an epoxide” is intended to encompass one or more epoxides. In other words, the term “an epoxide” refers to a single epoxide, or a mixture of two or more different epoxides. For example, the epoxide substrate may be a mixture of ethylene oxide and propylene oxide, a mixture of cyclohexene oxide and propylene oxide, a mixture of ethylene oxide and cyclohexene oxide, or a mixture of ethylene oxide, propylene oxide and cyclohexene oxide.

Polyether carbonate and polycarbonate ether is used herein interchangeably, and both refer to a polymer having at least one ether linkage and preferably multiple ether linkages and at least one carbonate linkage and preferably multiple carbonate linkages.

The term “continuous” used herein can be defined as the mode of addition of materials or may refer to the nature of the reaction method as a whole.

In terms of continuous mode of addition, the relevant materials are continually or constantly added during the course of a reaction. This may be achieved by, for example, adding a stream of material with either a constant flow rate or with a variable flow rate. In other words, the one or more materials are added in an essentially non-stop fashion. It is noted, however, that non-stop addition of the materials may need to be briefly interrupted for practical considerations, for example to refill or replace a container of the materials from which these materials are being added.

In terms of a whole reaction being continuous, the reaction may be conducted over a long period of time, such as a number of days, weeks, months, etc. In such a continuous reaction, reaction materials may be continually topped-up and/or products of the reaction may be tapped-off. It will be appreciated that although catalysts may not be consumed during a reaction, catalysts may in any case require topping-up, since tapping-off may deplete the amount of catalyst present.

A continuous reaction may employ continuous addition of materials.

The term “discontinuous” used herein means that the addition of the materials takes place in a portion-wise manner. This may be achieved by, for example, dropwise addition of the materials. Alternatively, the materials may be added in portions (i.e. batch fed) into the vessel, with timed intervals between additions. These timed intervals may be regular, or may change during the course of the reaction. Such timed intervals may be as little as a few minutes, or may be several hours. For example, the timed intervals may be between 1 minute and 12 hours; between 5 minutes and 6 hours; between 10 minutes and 4 hours; between 15 minutes and 3 hours; between 20 minutes and 2 hours; or between 30 minutes and 1 hour. If the materials are to be added in portions (i.e. batch fed), then there must be at least two discrete additions of the materials during the course of the reaction as a whole.

A continuous reaction may employ a discontinuous (i.e. batch-wise) addition of materials.

By surfactant molecule is meant a molecule which lowers the surface tension of the medium in which it is dissolved and/or the interfacial tension. In the context of an aqueous phase the surfactant will typically comprise a hydrophobic portion and a hydrophilic portion.

### DETAILED DESCRIPTION

The present invention relates to continuous and discontinuous methods for preparing surfactant molecules, by reacting an epoxide and carbon dioxide in the presence of a catalyst of formula (I), a double metal cyanide (DMC) catalyst and a monofunctional starter compound.

Accordingly, the present invention relates to a method for preparing a surfactant molecule, the method comprising reacting carbon dioxide and an epoxide in the presence of a double metal cyanide (DMC) catalyst, a catalyst of formula (I), and a monofunctional starter compound, wherein the catalyst of formula (I) has the following structure:

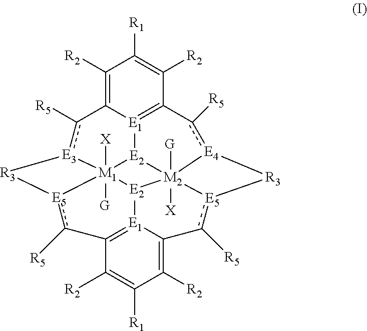

wherein M₁ and M₂ are independently selected from Zn(II), Cr(II), Co(II), Cu(II), Mn(II), Mg(II), Ni(II), Fe(II), Ti(II), V(II), Cr(III)-X, Co(III)-X, Mn(III)-X, Ni(III)-X, Fe(III)-X, Ca(II), Ge(II), Al(III)-X, Ti(III)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl; E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] , and wherein when E₃, E₄, E₅ or E₆ are NR₄, O or S, [symbol] is, [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)Rₓ, OSO₂Rₓ, OSORₓ, OSO(Rₓ)₂, S(O)Rₓ, ORₓ, phosphinate, halide, nitrate, hydroxyl, carbonate, amino, amido or optionally substituted aliphatic, heteroaliphatic, alicyclic, heteroalicyclic, aryl or heteroaryl, wherein each X may be the same or different and wherein X may form a bridge between M₁ and M₂;
Rₓ is independently hydrogen, or optionally substituted aliphatic, haloaliphatic, heteroaliphatic, alicyclic, heteroalicyclic, aryl, alkylaryl or heteroaryl; and G is absent or independently selected from a neutral or anionic donor ligand which is a Lewis base.

The method may comprise forming a mixture comprising monofunctional starter compound, epoxide, carbon dioxide, catalyst of formula (I), double metal cyanide (DMC) catalyst and optionally solvent, and subsequently increasing the temperature by at least 10° C.

The method may comprise the steps of:
(I) (a) mixing catalyst of formula (I), double metal cyanide (DMC) catalyst and optionally carbon dioxide and/or solvent with epoxide and optionally monofunctional starter compound and/or carbon dioxide to form mixture (α); or
   (b) mixing double metal cyanide (DMC) catalyst and optionally monofunctional starter compound, carbon dioxide and/or solvent with epoxide and optionally carbon dioxide and/or solvent to form mixture (α); or
   (c) mixing epoxide, catalyst of formula (I), monofunctional starter compound and carbon dioxide and optionally solvent to form mixture (α); or
   (d) mixing catalyst of formula (I), double metal cyanide (DMC) catalyst and optionally monofunctional starter compound, epoxide, carbon dioxide and/or solvent to form mixture (α); and
(II) adding one or more of monofunctional starter compound, epoxide, carbon dioxide, catalyst of formula (I), double metal cyanide (DMC) catalyst and/or solvent to mixture (α) to form mixture (β) comprising monofunctional starter compound, epoxide, carbon dioxide, catalyst of formula (I), double metal cyanide (DMC) catalyst and optionally solvent, and optionally increasing the temperature by at least 10° C.

The present invention relates to methods for preparing surfactant molecules. The method is preferably conducted in two or more stages. In this way, part of the reaction is allowed to start and then more of one or more of the reaction materials are added (in either a continuous or discontinuous manner) and/or the temperature of the reaction is increased in the second stage as the reaction continues.

Preferably the reaction occurs in a single reactor, i.e. steps (I) and (II) occur in the same reactor.

Adding certain components in the second step may be useful to increase activity of the catalysts and may lead to a more efficient process, compared with a process in which all of the materials are provided at the start of the reaction. Large amounts of some of the components present throughout the reaction may reduce efficiency of the catalysts. Adding material slowly to the reaction may prevent this reduced efficiency of the catalysts and/or may optimise catalyst activity.

Additionally, not loading the total amount of each component at the start of the reaction may lead to even catalysis, and more uniform polymer products. This in turn may lead to polymers having a narrower molecular weight distribution, desired ratio of ether to carbonate linkages, and/or an improved (i.e. a lower) polydispersity index.

Mixing only certain components in the first step and adding the remainder in the second step may also be useful for pre-activating catalysts. Such pre-activation may be achieved by mixing one or both catalysts with epoxide (and optionally other components), per step (I)(a) or (b) above. Pre-activation may be useful to prime one or both catalyst such that, upon addition of the remaining components in step (II), the efficiency of the reaction may increase.

It will be appreciated that the present invention relates to a reaction in which carbonate and ether linkages are added to a growing polymer chain. Mixing only certain components in the first step and adding the remainder in the second step may be useful for allowing part of the reaction to proceed before a second stage in the reaction.

In general terms, an aim of the present invention is to control the polymerisation reaction through controlled addition of materials. The methods herein may allow the product prepared by such methods to be tailored to the necessary requirements.

Mixture (α) formed by step (I) (b) may be held at a temperature of between about 50 to 150° C. prior to step (II), optionally between about 80 to 130° C.

Mixture (α) formed by steps (I) (a), (c) or (d) may be held at a temperature of between about 0 to 120° C. prior to step (II), optionally between about 40 to 100° C., optionally between about 50 to 90° C., between about 50 to 80° C., between about 55 to 80° C. or about 60 to 80° C. In step (II) the temperature may be increased to between 60 and 150° C., optionally between 65 and 150° C., optionally between 80 and 130° C. Optionally additional epoxide is also added.

Mixture (α) may be held for at least about 1 minute prior to step (II), optionally at least about 5 minutes, optionally at least about 15 minutes, optionally at least about 30 minutes, optionally at least about 1 hour, optionally at least about 2 hours, optionally at least about 5 hours.

Mixture (α) formed by steps (I)(c) may be held for at least about 1 minutes prior to step (II), optionally at least about 5 minutes, optionally at least about 15 minutes, optionally at least about 30 minutes, optionally at least about 1 hour, optionally at least about 2 hours, optionally at least about 3 hours, optionally at least about 4 hours, optionally at least about 8 hours, optionally at least about 16 hours.

Mixture (α) may comprise less than about 1 wt. % water, optionally less than about 0.5 wt. % water, optionally less than about 0.1 wt. % water, optionally less than about 0.05 wt. % water, optionally about 0 wt. % water. The presence of water in the mixture may cause de-activation of the or each catalyst. Thus, minimising the water content in the mixture is desired.

Step (I)(a) may comprise firstly mixing catalyst of formula (I), double metal cyanide (DMC) catalyst and optionally carbon dioxide to form mixture (α′), and subsequently adding epoxide and optionally monofunctional starter compound and/or carbon dioxide to form mixture (α). Conducting the method in this way may be useful for pre-activating one or both catalysts, as previously described.

Mixture (α′) may be held at a temperature of between about 0 to 250° C. prior to said subsequently adding, optionally about 40 to 150° C., optionally about 50 to 150° C., optionally about 70 to 140° C., optionally about 80 to 130° C.

The reaction method as a whole may be conducted on a batch-wise basis. In such instances, the method may employ a total amount of each of the relevant materials used in the reaction (such as the epoxide, monofunctional starter compound, etc.), and a proportion of that total amount may be added in different steps in the reaction.

The method may employ a total amount of epoxide, and wherein about 1 to 95% of the total amount of epoxide may be mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The method may employ a total amount of monofunctional starter compound, and wherein about 1 to 95% of the total amount of monofunctional starter compound may be mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The method may employ a total amount of catalyst of formula (I), and wherein about 1 to 100% of the total amount of catalyst of formula (I) may be mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The method may employ a total amount of double metal cyanide (DMC) catalyst, and wherein about 1 to 100% of the total amount of double metal cyanide (DMC) catalyst mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The method may employ a total amount of carbon dioxide, and wherein about 1 to 100% of the total amount of carbon dioxide may be mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The method may employ a total amount of solvent, and wherein about 1 to 100% of the total amount of solvent may be mixed in step (I), with the remainder added in step (II); optionally about 1 to 75% being mixed in step (I), optionally about 1 to 50%, optionally about 1 to 40%, optionally about 1 to 30%, optionally about 1 to 20%, optionally about 5 to 20%.

The total amount of the catalyst of formula (I) may be low, such that the methods of the invention may be carried out at low catalytic loading. For example, the catalytic loading of the catalyst of formula (I) may be in the range of about 1:100,000-300,000 [total catalyst of formula (I)]: [total epoxide], such as about 1:10,000-100,000 [total catalyst of formula (I)]: [total epoxide], e.g. in the region of about 1:10,000-50,000 [total catalyst of formula (I)]: [total epoxide], for example in the region of about 1:10,000 [total catalyst of formula (I)]: [total epoxide]. The ratios above are molar ratios. These ratios are the ratios of the total amount of catalyst of formula (I) to the total amount of epoxide used in the method.

The method may be continuous, wherein there is a predetermined molar ratio or weight ratio of epoxide to catalyst of formula (I) in mixture (β), and wherein the method further comprises:
III) adding epoxide to mixture (β) to form mixture (γ), said epoxide being added at an amount sufficient to bring the molar ratio or weight ratio of epoxide to catalyst of formula (I) in mixture (γ) to at least about 75% of said predetermined molar ratio or weight ratio, optionally wherein step (III) is repeated.

The method may be continuous, wherein there is a predetermined molar ratio or weight ratio of monofunctional starter compound to catalyst of formula (I) in mixture (β), and wherein the method further comprises:
(III) adding monofunctional starter compound to mixture (β) to form mixture (γ), said monofunctional starter compound being added in an amount sufficient to bring the molar ratio or weight ratio of monofunctional starter compound to catalyst of formula (I) in mixture (γ) to at least about 75% of said predetermined molar ratio or weight ratio, optionally wherein step (III) is repeated.

The method may be continuous, wherein there is a predetermined molar ratio or weight ratio of carbon dioxide to catalyst of formula (I) in mixture (β), and wherein the method further comprises:
(III) adding carbon dioxide to mixture (β) to form mixture (γ), said carbon dioxide being added in an amount sufficient to bring the molar ratio or weight ratio of carbon dioxide to catalyst of formula (I) in mixture (γ) to at least about 75% of said predetermined molar ratio or weight ratio, optionally wherein step (III) is repeated.

Step (III) may be conducted such that the molar ratio or weight ratio of epoxide, monofunctional starter compound, carbon dioxide and/or solvent to catalyst of formula (I) in the mixture (γ) does not fall below about 75% of said predetermined molar or weight ratio.

Step (III) may be conducted such that the molar ratios or weight ratios of epoxide, monofunctional starter compound, carbon dioxide and solvent to catalyst of formula (I) in mixture (γ) do not fall below about 75% of said predetermined molar or weight ratios.

The method may be continuous, wherein there is a predetermined amount of catalyst of formula (I) in mixture (β), and wherein the method further comprises:
(III) adding catalyst of formula (I) to mixture (β) to form mixture (γ), said catalyst of formula (I) being added in an amount sufficient to bring the amount of catalyst of formula (I) in mixture (γ) to about 50 to 550% of said predetermined amount, optionally wherein step (III) is repeated.

Step (III) may be conducted such that the amount of catalyst of formula (I) in the mixture (γ) does not fall below about 50% of said predetermined amount.

The method may be continuous, wherein there is a predetermined amount of double metal cyanide (DMC) catalyst in mixture (β), and wherein the method further comprises:
(III) adding double metal cyanide (DMC) catalyst to mixture (β) to form mixture (γ), said double metal cyanide (DMC) catalyst being added in an amount sufficient to bring the amount of double metal cyanide (DMC) catalyst in mixture (γ) to about 50 to 550% of said predetermined amount, optionally wherein step (III) is repeated.

Step (III) may be conducted such that the amount of double metal cyanide (DMC) catalyst in mixture (γ) does not fall below about 50% of said predetermined amount.

The rate at which the materials are added may be selected such that the temperature of the (exothermic) reaction does not exceed a selected temperature (i.e. that the materials are added slowly enough to allow any excess heat to dissipate such that the temperature of the remains approximately constant).

In instances where addition of materials (i.e. per step III) are repeated, the addition may be repeated one, two, three, four, five, six, seven, eight, nine, ten or more times.

The amount of catalyst of formula (I) and the amount of double metal cyanide (DMC) catalyst may be at a predetermined weight ratio of from about 300:1 to about 1:100 to one another, for example, from about 120:1 to about 1:75, such as from about 40:1 to about 1:50, e.g. from about 30:1 to about 1:30 such as from about 20:1 to about 1:1, for example from about 10:1 to about 2:1, e.g. from about 5:1 to about 1:5.

The double metal cyanide (DMC) catalyst may be dry-mixed with the other components.

The double metal cyanide (DMC) catalyst may be mixed as a slurry, said slurry comprising the double metal cyanide (DMC) catalyst and the monofunctional starter compound and/or solvent.

The catalyst of formula (I) may be dry-mixed with the other components.

The catalyst of formula (I) may be mixed as a solution, said solution comprising the catalyst of formula (I) and one or more of the monofunctional starter compound, epoxide and/or a solvent.

Epoxide may be added in step (II).

Catalyst of formula (I) may be added in step (II).

Double metal cyanide (DMC) catalyst may be added in step (II).

Monofunctional starter compound may be added in step (II).

Both epoxide and monofunctional starter compound may be added in step (II).

Epoxide, catalyst of formula (I), double metal cyanide (DMC) catalyst and/or monofunctional starter compound may be, independently, continuously added in step (II).

Epoxide, catalyst of formula (I), double metal cyanide (DMC) catalyst and/or monofunctional starter compound may be, independently, discontinuously added in step (II).

Carbon dioxide may be provided continuously.

The method may be carried out at a pressure of between about 1 bar and about 60 bar carbon dioxide, optionally about 1 bar and about 40 bar, optionally about 1 bar and about 20 bar, optionally between about 1 bar and about 15 bar, optionally about 1 bar and about 10 bar, optionally about 1 bar and about 5 bar.

The temperature of the reaction may increase during the course of the method.

The monofunctional starter compound used in the methods for forming surfactant molecules may comprise a group selected from a hydroxyl group (—OH), a thiol (—SH), an amine having at least one N—H bond (—NHR′), a group having at least one P—OH bond (e.g. —PR′(O)OH, PR′(O)(OH)₂ or —P(O)(OR′)(OH)), or a carboxylic acid group (—C(O)OH).

Thus, the monofunctional starter compound used in the methods for forming surfactant molecules may be of the formula (II):

Z—R^{Z} (II)

Z can be any group which has a —R^{Z} group attached to it. Thus, Z may be selected from optionally substituted alkyl, alkenyl, alkynyl, heteroalkyl, heteroalkenyl, heteroalkynyl, cycloalkyl, cycloalkenyl, hererocycloalkyl, heterocycloalkenyl, aryl, heteroaryl, or Z may be a combination of any of these groups, for example Z may be an alkylaryl, heteroalkylaryl, heteroalkylheteroaryl or alkylheteroaryl group. Optionally Z is alkyl, heteroalkyl, aryl, or heteroaryl.

R^{Z} may be —OH, —NHR′, —SH, —C(O)OH, —P(O)(OR′)(OH), —PR′(O)(OH)₂ or —PR′(O)OH, optionally R_{Z} is selected from —OH, —NHR′ or —C(O)OH, optionally R^{z} is selected from —OH or —C(O)OH.

R′ may be H, or optionally substituted alkyl, heteroalkyl, aryl, heteroaryl, cycloalkyl or heterocycloalkyl, optionally R′ is H or optionally substituted alkyl.

The method may comprise multiple monofunctional starter compounds. The multiple monofunctional starter compounds may be added as a mixture of monofunctional starter compounds or added at different stages. Preferably one or two different monofunctional starter compounds are present. Where the method comprises more than one step there may be two monofunctional starter compounds in mixture (β), wherein the monofunctional starter compound in step (I) is a first monofunctional starter compound, and wherein step (II) comprises:
(A) adding one or more of first monofunctional starter compound, epoxide, carbon dioxide, catalyst of formula (I), double metal cyanide (DMC) catalyst and/or solvent to mixture (α); and
(B) adding a second monofunctional starter compound and optionally epoxide, carbon dioxide, catalyst of formula (I), double metal cyanide (DMC) catalyst and/or solvent to form mixture (β) comprising first monofunctional starter compound, second monofunctional starter compound, epoxide, carbon dioxide, catalyst of formula (I), double metal cyanide (DMC) catalyst and optionally solvent.

Step (B) may be conducted at least about 1 minutes after step (A), optionally at least about 5 minutes, optionally at least about 15 minutes, optionally at least about 30 minutes, optionally at least about 1 hour, optionally at least about 2 hours, optionally at least about 5 hours.

The or each monofunctional starter compound preferably comprises a hydroxyl group.

Exemplary monofunctional starter substances include alcohols, phenols, amines, thiols and carboxylic acids; for example, alcohols such as methanol, ethanol, 1-and 2-propanol, 1- and 2-butanol, linear or branched C₃-C₂₀-monoalcohol such as tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-decanol, 1-dodecanol, phenol, 2-hydroxybiphenyl, 3-hydroxybiphenyl, 4-hydroxybiphenyl, 2-hydroxypyridine, 3-hydroxypyridine, and 4-hydroxypyridine, mono-ethers or esters of ethylene, propylene, polyethylene; polypropylene glycols such as ethylene glycol mono-methyl ether and propylene glycol mono-methyl ether, phenols such as linear or branched C₃-C₂₀ alkyl substituted phenols, for example nonyl-phenols or octyl phenols monofunctional carboxylic acids such as formic acid, acetic acid, propionic acid and butyric acid, fatty acids, such as stearic acid, palmitic acid, oleic acid, linoleic acid, linolenic acid, benzoic acid and acrylic acid, and monofunctional thiols such as ethanethiol, propane-1-thiol, propane-2-thiol, butane-1-thiol, 3-methylbutane-1-thiol, 2-butene-1-thiol, and thiophenol, or amines such as butylamine, tert-butylamine, pentylamine, hexylamine, aniline, aziridine, pyrrolidine, piperidine, and morpholine.

Preferably, the monofunctional starter is a linear or branched C₈-C₂₀ alcohol, such as 1-octanol, 1-decanol, 1-dodecanol, 1-tetradecanol, cetyl alcohol or stearyl alcohol, more preferably it is a linear or branched C₁₀-C₂₀ alcohol such as1-decanol, 1-dodecanol, 1-tetradecanol, cetyl alcohol or stearyl alcohol.

The monofunctional starter may be a mixture of related compounds, such as C₁₂₋₁₄ alcohols, C₁₆₋₁₈ alcohols, or C₁₈₋₂₀ alcohols.

The ratio of the monofunctional starter compound, to the catalyst of formula (I) may be in amounts of from about 1000:1 to about 1:1, for example, from about 750:1 to about 5:1, such as from about 500:1 to about 10:1, e.g. from about 250:1 to about 20:1, or from about 125:1 to about 30:1, or from about 50:1 to about 20:1. These ratios are molar ratios. These ratios are the ratios of the total amount of monofunctional starter to the total amount of the catalyst of formula (I) used in the method. These ratios may be maintained during the course of addition of materials.

The monofunctional starter may be pre-dried (for example with molecular sieves) to remove moisture. It will be understood that any of the above reaction conditions described may be combined. For example, the reaction may be carried out at 60 bar or less, such as about 30 bar or less, optionally 20 bar or less (e.g. 10 bar or less) and at a temperature in the range of from about 5° C. to about 200° C., e.g. from about 10° C. to about 150° C., such as from about 15° C. to about 100° C., for example, from about 20° C. to about 90° C. The method of the invention may be carried out at from about 45° C. to about 90° C.

The methods of the invention are capable of preparing surfactant molecules, which can be used, for example in cleaning products such as detergents. Hence, in a further aspect of the invention is provided use of a surfactant molecule formed as by the method of the first aspect of the present invention in a cleaning product as well as a composition comprising a surfactant molecule formed as by the method of the first aspect of the invention wherein the composition is a surfactant formulation for a cleaning product.

In particular, the continuous and discontinuous methods of the present invention may provide surfactant molecules having a low polydispersity index (PDI).

The methods of the invention are capable of producing surfactant molecules in which the amount of ether and carbonate linkages can be controlled. Thus, the invention may provide a surfactant molecule which has n ether linkages and m carbonate linkages, wherein n and m are integers, and wherein m/(n+m) is from greater than zero to less than 1. It will therefore be appreciated that n≥1 and m≥1.

For example, the methods of the invention are capable of preparing surfactant molecules having a wide range of m/(n+m) values. It will be understood that m/(n+m) may be about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.05 to about 0.95, from about 0.10 to about 0.90, from about 0.15 to about 0.85, from about 0.20 to about 0.80, or from about 0.25 to about 0.75, etc.

As set out above, the methods of the invention are capable of preparing surfactant molecules where m/(n+m) is from about 0.1 to about 0.5, e.g. from about 0.1 to about 0.3.

Thus, the methods of the invention make it possible to prepare surfactant molecules having a moderate proportion of carbonate linkages, e.g. m/(n+m) may be greater than about 0.1, such as from greater than about 0.1 to less than about 0.5, e.g. about 0.15 to about 0.4, e.g. about 0.2 to about 0.4.

For example, the surfactant molecules produced by the methods of the invention may have the following formula (III or IV):

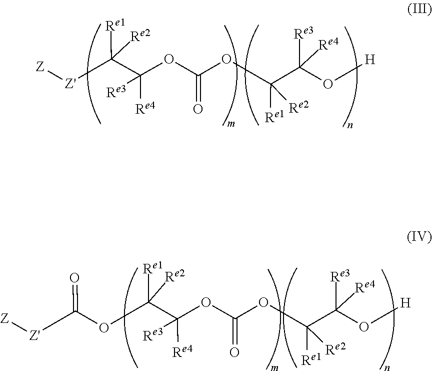

It will be appreciated that the identity of Z and Z′ will depend on the nature of the monofunctional starter compound, and that the identity of R^{e1}, R^{e2}, R^{e3} and R^{e4} will depend on the nature of the epoxide used to prepare the surfactant molecule. m and n define the amount of the carbonate and ether linkages in the surfactant molecule.

The skilled person will understand that in the polymers of formulas (III and IV), the adjacent epoxide monomer units in the backbone may be head-to-tail linkages, head-to-head linkages or tail-to-tail linkages.

It will also be appreciated that formulas (III and IV) are not intended to depict the carbonate links and the ether links as being present in two separate sections, but instead to illustrate the ratio of carbonate to ether linkages (m to n). The carbonate and ether repeating units may be randomly distributed along the polymer backbone.

Thus, the surfactant molecule prepared by the methods of the invention (e.g. a polymer of formula (III or IV)) may be referred to as a random copolymer, a statistical copolymer, or a periodic copolymer.

Without wishing to be bound by theory, typically the portion of the surfactant molecule derived from the monofunctional starter (Z) forms the hydrophobic portion of the surfactant molecule and the polyether carbonate polymer chain forms the hydrophilic portion of the surfactant.

The skilled person will appreciate that the wt % of carbon dioxide incorporated into a polymer cannot be definitively used to determine the amount of carbonate linkages in the polymer backbone. For example, two polymers which incorporate the same wt % of carbon dioxide may have very different ratios of carbonate to ether linkages. This is because the “wt % incorporation” of carbon dioxide does not take into account the length and nature of the monofunctional starter compound. For instance, if one polymer (Mn 2000 g/mol) is prepared using a monofunctional starter with a molar mass of 100 g/mol, and another polymer (Mn also 2000 g/mol) is prepared using a monofunctional starter having a molar mass of 500 g/mol, and both the resultant polymers have the same ratio of m/n then the wt % of carbon dioxide in the polymers will be different due to the differing proportion of the mass of the monofunctional starter in the overall polymer molecular weight (Mn). For example, if m/(m+n) was 0.5, the two polyols described would have carbon dioxide contents of 26.1 wt % and 20.6 wt % respectively.

As highlighted above, the methods of the invention are capable of preparing surfactant molecules which have a wide range of carbonate to ether linkages (e.g. m/(n+m) can be from greater than zero to less than 1), which, when using ethylene oxide, corresponds to incorporation of up to about 50 wt % carbon dioxide. This is surprising, as DMC catalysts which have previously been reported can generally only prepare surfactant molecules from monofunctional starters, ethylene oxide and CO₂ having a ratio of carbonate to ether linkages of up to ˜0.2, and these amounts can usually only be achieved at high pressures of carbon dioxide, such as 50 bar.

All other things being equal, polyethers have higher temperatures of degradation than polycarbonates produced from epoxides and carbon dioxide. Therefore, a surfactant having a statistical or random distribution of ether and carbonate linkages will have a higher temperature of degradation than a polycarbonate surfactant, or a surfactant having blocks of carbonate linkages. Temperature of thermal degradation can be measured using thermal gravimetric analysis (TGA).

As set out above, the methods of the invention prepare random copolymers, statistical copolymers, or periodic copolymers. Thus, the carbonate linkages are not in a single block, thereby providing a polymer which has improved properties, such as improved thermal degradation, as compared to a polycarbonate surfactants. The polymer prepared by the methods of the invention may be a random copolymer or a statistical copolymer.

The surfactant molecule prepared by the methods of the invention may be of formula (III) or (IV), in which n and m are integers of 1 or more, the sum of all m and n groups is from 4 to 200, and wherein m/(m+n) is in the range of from greater than zero to less than 1.00. As set out above, m/(n+m) may be from about 0.05, about 0.10, about 0.15, about 0.20, about 0.25, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, or within any range prepared from these specific values. For example, m/(n+m) may be from about 0.1 to about 0.5, from about 0.15 to about 0.4, from about 0.2 to about 0.0.4, from about 0.0.05 to about 0.5, or from about 0.05 to about 0.3, etc.

The skilled person will also appreciate that the surfactant must contain at least one carbonate and at least one ether linkage.

Each R^{e1} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. R^{e1} may be selected from H or optionally substituted alkyl.

Each R^{e2} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. R^{e2} may be selected from H or optionally substituted alkyl.

Each R^{e3} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. R^{e3} may be selected from H or optionally substituted alkyl.

Each R^{e4} may be independently selected from H, halogen, hydroxyl, or optionally substituted alkyl, alkenyl, alkynyl, cycloalkyl, heterocycloalkyl, aryl, heteroaryl, heteroalkyl or heteroalkenyl. R^{e4} may be selected from H or optionally substituted alkyl.

It will also be appreciated that R^{e1} (or R^{e2}) and R^{e3} (or R^{e4}) may together form a saturated, partially unsaturated or unsaturated ring containing carbon and hydrogen atoms, and optionally one or more heteroatoms (e.g. O, N or S). For example, R^{e1} and R^{e3} may together form a 5 or six membered ring.

As set out above, the nature of R^{e1}, R^{e2}, R^{e3} and R^{e4} will depend on the epoxide used in the reaction. If the epoxide is cyclohexene oxide (CHO), then R^{e1} and R^{e3} will together form a six-membered alkyl ring (e.g. a cyclohexyl ring). If the epoxide is ethylene oxide, then R^{e1}, R^{e2}, R^{e3} and R^{e4} will each be H. If the epoxide is propylene oxide, then R^{e1}, R^{e2} and R^{e4} will be H and R^{e3} will be methyl (or R^{e1} will be methyl and R^{e3} will be H, depending on how the epoxide is added into the polymer backbone). If the epoxide is butylene oxide, then R^{e1} R^{e2} and R^{e4} will be H and R^{e3} will be ethyl (or R^{e1} will be ethyl and R^{e3} will be H). If the epoxide is styrene oxide, then R^{e1}, R^{e2} and R^{e4} may be hydrogen, and R^{e3} may be phenyl (or R^{e1} will be phenyl and R^{e3} will be H).

It will also be appreciated that if a mixture of epoxides is used, then each occurrence of R^{e1} R^{e2}, R^{e3} and/or R^{e4} may not be the same, for example if a mixture of ethylene oxide and propylene oxide are used, R^{e1}, R^{e2}, R^{e3} and R^{e4} may each be independently hydrogen or methyl.

Thus, R^{e1} R^{e2}, R^{e3} and R^{e4} may be independently selected from hydrogen, alkyl or aryl, or R^{e1} (or R^{e2}) and R^{e3} (or R^{e4}) may together form a cyclohexyl ring, R^{e1} R^{e2}, R^{e3} and R^{e4}may be independently selected from hydrogen, methyl, ethyl or phenyl, or R^{e1} (or R^{e2}) and R^{e3} (or R^{e4}) may together form a cyclohexyl ring.

Z′ corresponds to R^{z}, except that a bond replaces the labile hydrogen atom. Therefore, the identity of Z′ depends on the definition of R^{Z} in the monofunctional starter compound. Thus, it will be appreciated that Z′ may be —O—, —NR′—, —S—, —C(O)O—, —P(O)(OR′)O—, —PR′(O)(O—)₂ or —PR′(O)O— (wherein R′ may be H, or optionally substituted alkyl, heteroalkyl, aryl, heteroaryl, cycloalkyl or heterocycloalkyl, optionally R′ is H or optionally substituted alkyl), optionally Z′ may be —C(O)O—, —NR′— or —O—, each Z′ may be —O—, —C(O)O— or a combination thereof, optionally each Z′ may be —O—.

Z also depends on the nature of the monofunctional starter compound. Thus, Z may be selected from optionally substituted alkyl, alkenyl, alkynyl, heteroalkyl, heteroalkenyl, heteroalkynyl, cycloalkyl, cycloalkenyl, hererocycloalkyl, heterocycloalkenyl, aryl, heteroaryl, or Z may be a combination of any of these groups, for example Z may be an alkylaryl, heteroalkylaryl, heteroalkylheteroaryl or alkylheteroaryl group. Optionally Z is alkyl, heteroalkyl, aryl, or heteroaryl, e.g. alkyl or heteroalkyl. It will be appreciated that each of the above groups may be optionally substituted, e.g. by alkyl.

For some applications, particularly when Z is —O— and Z is a C₁-C₂₅ alkyl group, it may be desirable to provide the surfactant molecule with a relatively short hydrophobic portion. In this case when Z′ is —O—, Z is preferably a C₁-C₈ alkyl group.

In other applications, particularly when Z is —O— and Z is a C₁-C₂₅ alkyl group, it may be desirable to provide the surfactant molecule with a relatively long hydrophobic portion. In this case when Z′ is —O—, Z is preferably a C₉-C₂₅ alkyl group.

The skilled person will understand that each of the above features may be combined. For example, R^{e1} R^{e2}, R^{e3} and R^{e4} may be independently selected from hydrogen, alkyl or aryl, or R^{e1} (or R^{e2}) and R^{e3} (or R^{e4}) may together form a cyclohexyl ring, each Z′ may be —O—, —C(O)O— or a combination thereof (optionally each Z′ may be —O—), and Z may be optionally substituted alkyl, heteroalkyl, aryl, or heteroaryl, e.g. alkyl or heteroalkyl.

The surfactants produced by the methods of the invention are optionally low molecular weight oligomers. It will be appreciated that the nature of the epoxide used to prepare the surfactant molecule will have an impact on the resulting molecular weight of the product. Thus, the upper limit of n+m is used herein to define “low molecular weight” polymers of the invention.

The methods of the invention can advantageously prepare a surfactant molecule having a narrow molecular weight distribution. In other words, the surfactant molecule may have a low polydispersity index (PDI). The PDI of a polymer is determined by dividing the weight average molecular weight (M_{w}) by the number average molecular weight (Mₙ) of a polymer, thereby indicating the distribution of the chain lengths in the polymer product. It will be appreciated that PDI becomes more important as the molecular weight of the polymer decreases, as the percent variation in the polymer chain lengths will be greater for a short chain polymer as compared to a long chain polymer, even if both polymers have the same PDI.

Optionally the polymers produced by the methods of the invention have a PDI of from about 1 to less than about 2, optionally from about 1 to less than about 1.75, such as from about 1 to less than about 1.5, from about 1 to less than about 1.3, from about 1 to less than about 1.2, and from about 1 to less than about 1.1.

The Mₙ and M_{w}, and hence the PDI of the polymers produced by the methods of the invention may be measured using Gel Permeation Chromatography (GPC). For example, the GPC may be measured using an Agilent 1260 Infinity GPC machine with two Agilent PLgel μ-m mixed-E columns in series. The samples may be measured at room temperature (293K) in THF with a flow rate of 1 mL/min against narrow polystyrene standards (e.g. polystyrene low EasiVials supplied by Agilent Technologies with a range of Mn from 405 to 49,450 g/mol). Optionally, the samples may be measured against poly (ethylene glycol) standards, such as polyethylene glycol easivials supplied by Agilent Technologies.

Optionally, the surfactant molecules produced by the methods of the invention may have a molecular weight in the range of from about 400 to about 10,000 Da, optionally from about 500 to about 3,000 Da or from about 500 to about 2,000 Da.

The methods of the present invention may be carried out in the presence of a solvent, however it will also be appreciated that the methods may be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc. The solvent may be toluene, hexane, acetone, ethyl acetate and n-butyl acetate.

The solvent may act to dissolve one or more of the materials. However, the solvent may also act as a carrier, and be used to suspend one or more of the materials in a suspension. Solvent may be required to aid addition of one or more of the materials during the steps of the methods of the present invention.

The epoxide which is used in the methods may be any suitable compound containing an epoxide moiety. Exemplary epoxides include ethylene oxide, propylene oxide, butylene oxide and cyclohexene oxide. Preferably the epoxide is ethylene oxide, propylene oxide or a mixture of ethylene oxide and propylene oxide. More preferably the epoxide is ethylene oxide.

The epoxide may be purified (for example by distillation, such as over calcium hydride) prior to reaction with carbon dioxide. For example, the epoxide may be distilled prior to being added.

The methods of the present invention can be carried out on any scale. The method may be carried out on an industrial scale. As will be understood by the skilled person, catalytic reactions often involve the generation of heat (i.e. catalytic reactions are generally exothermic). The generation of heat during a small-scale reaction is unlikely to be problematic, as any increase in temperature can be controlled relatively easily by, for example, the use of an ice bath. With larger scale reactions, and particularly industrial scale reactions, the generation of heat during a reaction can be problematic and potentially dangerous. Thus, the gradual addition of materials either manner as described herein may allow the rate of the catalytic reaction to be controlled and can minimise the build-up of excess heat in. The rate of the reaction may be controlled, for example, by adjusting the flow rate of the materials during addition. Thus, the methods of the present invention have particular advantages if applied to large, industrial scale catalytic reactions.

The temperature may increase during the course of the methods of the invention. For example, the methods may be initiated at a low temperature (e.g. at a temperate of about 50° C. to 80° C. or less) and reaction mixture may be allowed to increase in temperature during the course of the methods. For example, the temperature of the reaction mixture increases during the course of the method of the invention from about 50° C. at the start of the reaction to about 80° C. at the end of the reaction. This increase in temperature may be gradual, or may be rapid. This increase in temperature may be a result of applying external heating sources, or may be achieved via an exothermic reaction, as described above.

The temperature of the reaction mixture may decrease during the course of the methods of the invention. For example, the methods may be initiated at a high temperature (e.g. at a temperate of about 90-150° C. and the reaction mixture may be cooled during the course of the methods (e.g. at a temperate of about 50° C. to 80° C. or less). This decrease in temperature may be gradual, or may be rapid. This decrease in temperature may be a result of applying external cooling sources, as described above.

The present invention also relates to a surfactant molecule obtainable by the methods discussed above, preferably wherein the surfactant molecule is according to formula (III) or formula (IV) as set out above. The present invention also relates to the use of a surfactant molecule obtainable by the methods discussed above in a cleaning product and a composition comprising said surfactant molecule where the composition is a surfactant formulation for a cleaning product.

The catalyst of formula (I) is bimetallic phenolate such as those disclosed in WO2009/130470, WO2013/034750, WO2016/012786, WO2016/012785, WO2012037282 and WO2019048878A1 (the contents of which are incorporated herein by reference)

Each of the occurrences of the groups R₁ and R₂ in formula (I) may be the same or different, and R₁ and R₂ can be the same or different.

Optionally, each occurrence of R₂ is the same, and is hydrogen. R₃ may be an optionally substituted alkylene group, optionally wherein R₃ is an optionally substituted C₂ or C₃ alkylene group. Exemplary options for R₃ include ethylenyl, 2,2-fluoropropylenyl, 2,2-dimethylpropylenyl, propylenyl, butylenyl, phenylenyl, cyclohexylenyl or biphenylenyl. Optionally R₃ is a substituted propylenyl, such as 2,2-di (alkyl) propylenyl, optionally 2,2-dimethylpropylenyl.

Optionally, E₃, E₄, E₅ and E₆ are each independently selected from NR₄, O and S. Exemplary options for R₄ include H, Me, Et, Bn, iPr, tBu or Ph, and —CH₂-(pyridine).

Optionally each R₄ is hydrogen or alkyl. Optionally, both occurrences of E₁ are C and both occurrences of E₂ are O. Alternatively, E₁ may be C, when E₂ is O. Each X may be the same or different and optionally each X is the same. It will also be appreciated that X may form a bridge between the two metal centres.

Optionally each X is the same and is selected from the group OC(O)Rₓ. Optionally each X is the same and is selected from OAc, O₂CCF₃, or O₂C (CH₂)₃Cy. Optionally each X is the same and is OAc. Optionally, at least one of M₁ and M₂ is selected from Zn(II), Cr(III)-X, Co(II), Mn(II), Mg(II), Ni(II), Fe(II), and Fe(III)-X, optionally at least one of M₁ and M₂ is selected from Mg(II), Zn(II), and Ni(II), for example, at least one of M₁ and M₂ is Ni(II).

DMC catalysts are complicated compounds which comprise at least two metal centres and cyanide ligands. The DMC catalyst may additionally comprise at least one of: one or more complexing agents, water, a metal salt and/or an acid (e.g. in non-stoichiometric amounts).

The first two of the at least two metal centres may be represented by M′ and M″.

M′ may be selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III), M′ is optionally selected from Zn(II), Fe(II), Co(II) and Ni(II), optionally M′ is Zn(II).

M″ is selected from Fe(II), Fe(III), Co(II), Co(III), Cr(II), Cr(III), Mn(II), Mn(III), Ir(III), Ni(II), Rh(III), Ru(II), V(IV), and V(V), optionally M″ is selected from Co(II), Co(III), Fe(II), Fe(III), Cr(III), Ir(III) and Ni(II), optionally M″ is selected from Co(II) and Co(III).

It will be appreciated that the above optional definitions for M′ and M″ may be combined. For example, optionally M′ may be selected from Zn(II), Fe(II), Co(II) and Ni(II), and M″ may optionally selected form be Co(II), Co(III), Fe(II), Fe(III), Cr(III), Ir(III) and Ni(II). For example, M′ may optionally be Zn(II) and M″ may optionally be selected from Co(II) and Co(III).

If a further metal centre(s) is present, the further metal centre may be further selected from the definition of M′ or M″.

Examples of DMC catalysts which can be used in the process of the invention include those described in U.S. Pat. Nos. 3,427,256, 5,536,883, 6,291,388, 6,486,361, 6,608,231, 7,008,900, 5,482,908, 5,780,584, 5,783,513, 5,158,922, 5,693,584, 7,811,958, 6,835,687, 6,699,961, 6,716,788, 6,977,236, 7,968,754, 7,034,103, 4,826,953, 4,500,704, 7,977,501, 9,315,622, EP-A-1568414, EP-A-1529566, and WO 2015/022290, the entire contents of which, especially, insofar as they relate to DMC catalysts for the reactions as defined herein, are incorporated herein by reference.

It will be appreciated that the DMC catalyst may comprise:

M′_{d}[M″ₑ(CN)_{f}]_{g}

wherein M′ and M″ are as defined above, d, e, f and g are integers, and are chosen to such that the DMC catalyst has electroneutrality. Optionally, d is 3. Optionally, e is 1. Optionally f is 6. Optionally g is 2. Optionally, M′ is selected from Zn(II), Fe(II), Co(II) and Ni(II), optionally M′ is Zn(II). Optionally M″ is selected from Co(II), Co(III), Fe(II), Fe(III), Cr(III), Ir(III) and Ni(II), optionally M″ is Co(II) or Co(III).

It will be appreciated that any of these optional features may be combined, for example, d is 3, e is 1, f is 6 and g is 2, M′ is Zn(II) and M″ is Co(III).

Suitable DMC catalysts of the above formula may include zinc hexacyanocobaltate (III), zinc hexacyanoferrate (III), nickel hexacyanoferrate (II), and cobalt hexacyanocobaltate (III).

There has been a lot of development in the field of DMC catalysts, and the skilled person will appreciate that the DMC catalyst may comprise, in addition to the formula above, further additives to enhance the activity of the catalyst. Thus, while the above formula may form the “core” of the DMC catalyst, the DMC catalyst may additionally comprise stoichiometric or non-stoichiometric amounts of one or more additional components, such as at least one complexing agent, an acid, a metal salt, and/or water.

For example, the DMC catalyst may have the following formula:

M′_{d}[M″ₑ(CN)_{f}]_{g}·hM′″X″ᵢ·jR^{c}·kH₂O·lHᵣX′″

wherein M′, M″, X″', d, e, f and g are as defined above. M″ can be M′ and/or M″. X″ is an anion selected from halide, oxide, hydroxide, sulphate, carbonate, cyanide, oxalate, thiocyanate, isocyanate, isothiocyanate, carboxylate and nitrate, optionally X″ is halide. i is an integer of 1 or more, and the charge on the anion X″ multiplied by i satisfies the valency of M″′. r is an integer that corresponds to the charge on the counterion X″′. For example, when X″′ is Cl⁻, r will be 1. l is 0, or a number between 0.1 and 5. Optionally, l is between 0.15 and 1.5.

R^{c} is a complexing agent or a combination of one or more complexing agents. For example, R^{c} may be a (poly) ether, a polyether carbonate, a polycarbonate, a poly (tetramethylene ether diol), a ketone, an ester, an amide, an alcohol (e.g. a C₁₋₈ alcohol), a urea and the like, such as propylene glycol, polypropylene glycol, (m) ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol, sec-butyl alcohol, 3-buten-1-ol, 2-methyl -3-buten-2-ol, 2-methyl-3-butyn-2-ol, 3-methyl-1-pentyn-3-ol or a combination thereof, for example, R^{c} may be tert-butyl alcohol, dimethoxyethane, or polypropylene glycol.

As indicated above, more than one complexing agent may be present in the DMC catalysts used in the present invention. Optionally one of the complexing agents of R^{c} may be a polymeric complexing agent. Optionally, R_{c} may be a combination of a polymeric complexing agent and a non-polymeric complexing agent. Optionally, a combination of the complexing agents tert-butyl alcohol and polypropylene glycol may be present.

It will be appreciated that if the water, complexing agent, acid and/or metal salt are not present in the DMC catalyst, h, j, k and/or I will be zero respectively. If the water, complexing agent, acid and/or metal salt are present, then h, j, k and/or l are a positive number and may, for example, be between 0 and 20. For example, h may be between 0.1 and 4. j may be between 0.1 and 6. k may be between 0 and 20, e.g. between 0.1 and 10, such as between 0.1 and 5. l may be between 0.1 and 5, such as between 0.15 and 1.5.

The polymeric complexing agent is optionally selected from a polyether, a polycarbonate ether, and a polycarbonate. The polymeric complexing agent may be present in an amount of from about 5% to about 80% by weight of the DMC catalyst, optionally in an amount of from about 10% to about 70% by weight of the DMC catalyst, optionally in an amount of from about 20% to about 50% by weight of the DMC catalyst.

The DMC catalyst, in addition to at least two metal centres and cyanide ligands, may also comprise at least one of: one or more complexing agents, water, a metal salt and/or an acid, optionally in non-stoichiometric amounts.

An exemplary DMC catalyst is of the formula Zn₃[Co(CN)₆]₂·hZnCl₂·kH₂O·j[(CH₃)₃COH], wherein h, k and j are as defined above. For example, h may be from 0 to 4 (e.g. from 0.1 to 4), k may be from 0 to 20 (e.g. from 0.1 to 10), and j may be from 0 to 6 (e.g. from 0.1 to 6). As set out above, DMC catalysts are complicated structures, and thus, the above formulae including the additional components is not intended to be limiting. Instead, the skilled person will appreciate that this definition is not exhaustive of the DMC catalysts which are capable of being used in the invention.

The DMC catalyst may be pre-activated. Such pre-activation may be achieved by mixing one or both catalysts with alkylene oxide (and optionally other components). Pre-activation of the DMC catalyst is useful as it enables safe control of the reaction (preventing uncontrolled increase of unreacted monomer content) and removes unpredictable activation periods.

### EXAMPLES

### Methods

Nuclear Magnetic Resonance Spectroscopy 1H NMR spectra were recorded on a Bruker AV-400 instrument, using the solvent CDCl₃.

### Gel Permeation Chromatography

GPC measurements were carried out against narrow polydispersity poly (ethylene glycol) or polystyrene standards in THF using an Agilent 1260 Infinity machine equipped with Agilent PLgel Mixed-E columns.

### Mass Spectroscopy

All mass spectrometry measurements were performed using a MALDI micro MX micromass instrument.

### Catalyst 1

A 100 mL parr pressure reactor containing 1-decanol (5.2 g, 27.9 mmol) and a DMC catalyst (a zinc hexacyanocobaltate catalyst containing t-butanol and polyether co-ligands) (9.6 mg) was dried at approx. 100° C. for 30 mins. To this was charged catalyst 1 (a macrocyclic phenolate catalyst containing two Ni centres conforming to structure (I)) (96 mg) and Ethylene Oxide EO, (17.6 g, 400 mmol).

The vessel was pressurized to approx. 3 barg with CO₂ and heated to ˜ 60° C. upon which the pressure was adjusted to a constant 7 barg with CO₂.

The pressure was maintained at 7 bar, but the temperature ramped up in steps after 8 h to 70° C., after 24 h total to 75° C., 32 h total to 80° C., 40 h to 85° C., 50 h to 95° C. After 66 hours total, the reaction was cooled to below room temperature, vented and analysed by NMR and GPC to give a surfactant molecule that is C₁₂—(CO₂)_{2.3}(EO)_{12.6}, with ˜12.1 wt % CO₂ and a mass of 820 g/mol (polydispersity 1.44).

1. A method for preparing a surfactant molecule, the method comprising reacting carbon dioxide and an epoxide in the presence of a double metal cyanide (DMC) catalyst, a catalyst of formula (I), and a monofunctional starter compound,
wherein the catalyst of formula (I) has the following structure: 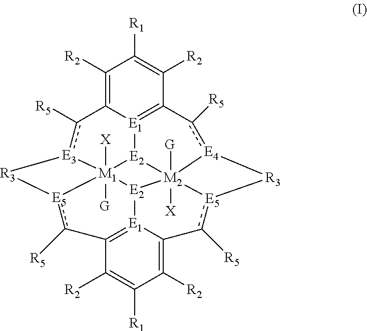
Wherein M₁ and M₂ are independently selected from Zn(II), Cr(Il), Co(II), Cu(II), Mn(II), Mg(II), Ni(II), Fe(II), Ti(II), V(II), Cr(III)-X, Co(III)-X, Mn(III)-X, Ni(III)-X, Fe(III) -X, Ca(II), Ge(II), Al(III)-X, Ti(III)-X, V(III)-X, Ge(IV)-(X)₂ or Ti(IV)-(X)₂;
R₁ and R₂ are independently selected from hydrogen, halide, a nitro group, a nitrile group, an imine, an amine, an ether group, a silyl group, a silyl ether group, a sulfoxide group, a sulfonyl group, a sulfinate group or an acetylide group or an optionally substituted alkyl, alkenyl, alkynyl, haloalkyl, aryl, heteroaryl, alkoxy, aryloxy, alkylthio, arylthio, alicyclic or heteroalicyclic group;
R₃ is independently selected from optionally substituted alkylene, alkenylene, alkynylene, heteroalkylene, heteroalkenylene, heteroalkynylene, arylene, heteroarylene or cycloalkylene, wherein alkylene, alkenylene, alkynylene, heteroalkylene, heteroalkenylene and heteroalkynylene, may optionally be interrupted by aryl, heteroaryl, alicyclic or heteroalicyclic;
R₅ is independently selected from H, or optionally substituted aliphatic, heteroaliphatic, alicyclic, heteroalicyclic, aryl, heteroaryl, alkylheteroaryl or alkylaryl;
E₁ is C, E₂ is O, S or NH or E₁ is N and E₂ is O;
E₃, E₄, E₅ and E₆ are selected from N, NR₄, O and S, wherein when E₃, E₄, E₅ or E₆ are N, [symbol] is [symbol] , and wherein when E₃, E₄, E₅ or E₆ are NR₄, O or S, [symbol] is [symbol] ;
R₄ is independently selected from H, or optionally substituted aliphatic, heteroaliphatic, alicyclic, heteroalicyclic, aryl, heteroaryl, alkylheteroaryl, -alkylC(O)OR₁₉ or -alkylC≡N or alkylaryl;
X is independently selected from OC(O)Rₓ, OSO₂Rₓ, OSORₓ, OSO(Rₓ)₂, S(O)Rₓ, ORₓ, phosphinate, halide, nitrate, hydroxyl, carbonate, amino, amido or optionally substituted aliphatic, heteroaliphatic, alicyclic, heteroalicyclic, aryl or heteroaryl;
Rₓ is independently hydrogen, or optionally substituted aliphatic, haloaliphatic, heteroaliphatic, alicyclic, heteroalicyclic, aryl, alkylaryl or heteroaryl; and
G is absent or independently selected from a neutral or anionic donor ligand which is a Lewis base.

2. The method for preparing a surfactant molecule according to claim 1 comprising forming a mixture comprising monofunctional starter compound, epoxide, carbon dioxide, catalyst of formula (I), double metal cyanide (DMC) catalyst and optionally solvent, and subsequently increasing the temperature by at least 10° C.

3. The method for preparing a surfactant molecule according to claim 1, comprising the steps of:
(I) (a) mixing catalyst of formula (I), double metal cyanide (DMC) catalyst and optionally carbon dioxide and/or solvent with epoxide and optionally monofunctional starter compound and/or carbon dioxide to form mixture (α); or
(b) mixing double metal cyanide (DMC) catalyst and optionally monofunctional starter compound, carbon dioxide and/or solvent with epoxide and optionally carbon dioxide and/or solvent to form mixture (α); or
(c) mixing epoxide, catalyst of formula (I), monofunctional starter compound and carbon dioxide and optionally solvent to form mixture (α); or
(d) mixing catalyst of formula (I), double metal cyanide (DMC) catalyst and optionally monofunctional starter compound, epoxide, carbon dioxide and/or solvent to form mixture (α); and
(II) adding one or more of monofunctional starter compound, epoxide, carbon dioxide, catalyst of formula (I), double metal cyanide (DMC) catalyst and/or solvent to mixture (α) to form mixture (β) comprising monofunctional starter compound, epoxide, carbon dioxide, catalyst of formula (I), double metal cyanide (DMC) catalyst and optionally solvent; and/or increasing the reaction temperature by 10° C. or more.

4. The method of claim 3, wherein mixture (α) is held at a temperature of between about 50 to 90° C. prior to step (II).

5. The method of claim 3, wherein in step (II) the temperature is increased to between about 60 and 150° C., and optionally additional epoxide is added.

6. The method of claim 1, wherein the epoxide is ethylene oxide, propylene oxide or a mixture of ethylene oxide and propylene oxide.

7. The method of claim 3, wherein mixture (α) is held for at least about 1 minute prior to step (II).

8. The method of claim 3, during step (c), wherein mixture (α) is held for at least about 1 minutes prior to step (II).

9. The method of claim 4, wherein during step (a) step (I) comprises firstly mixing catalyst of formula (I), double metal cyanide (DMC) catalyst and optionally carbon dioxide to form mixture (α′), and subsequently adding epoxide and optionally monofunctional starter compound and/or carbon dioxide to form mixture (α).

10. The method of claim 9, wherein mixture (α′) is held at a temperature of between about 0 to 250° C.

11. The method of claim 3, wherein the method is continuous, wherein there is a predetermined molar ratio or weight ratio of epoxide to catalyst of formula (I) in mixture (β), and wherein the method further comprises:
(III) adding epoxide to mixture (β) to form mixture (γ), said epoxide being added at an amount sufficient to bring the molar ratio or weight ratio of epoxide to catalyst of formula (I) in mixture (γ) to at least about 75% of said predetermined molar ratio or weight ratio, optionally wherein step (III) is repeated.

12. The method of claim 3, wherein the method is continuous, wherein there is a predetermined molar ratio or weight ratio of monofunctional starter compound to catalyst of formula (I) in mixture (β), and wherein the method further comprises:
(III) adding monofunctional starter compound to mixture (β) to form mixture (γ), said monofunctional starter compound being added in an amount sufficient to bring the molar ratio or weight ratio of monofunctional starter compound to catalyst of formula (I) in mixture (γ) to at least about 75% of said predetermined molar ratio or weight ratio, optionally wherein step (III) is repeated.

13. The method of claim 3, wherein the method is continuous, wherein there is a predetermined molar ratio or weight ratio of carbon dioxide to catalyst of formula (I) in mixture (β), and wherein the method further comprises:
(III) adding carbon dioxide to mixture (β) to form mixture (γ), said carbon dioxide being added in an amount sufficient to bring the molar ratio or weight ratio of carbon dioxide to catalyst of formula (I) in mixture (γ) to at least about 75% of said predetermined molar ratio or weight ratio, optionally wherein step (III) is repeated.

14. The method of claim 3, wherein the method is continuous, wherein there is a predetermined amount of double metal cyanide (DMC) catalyst in mixture (β), and wherein the method further comprises:
(III) adding double metal cyanide (DMC) catalyst to mixture (β) to form mixture (γ), said double metal cyanide (DMC) catalyst being added in an amount sufficient to bring the amount of double metal cyanide (DMC) catalyst in mixture (γ) to about 50 to 550% of said predetermined amount, optionally wherein step (III) is repeated.

15. The method of claim 1, wherein the amount of said catalyst of formula (I) and the amount of said double metal cyanide (DMC) catalyst are at a predetermined weight ratio of from about 300:1 to about 1:100 to one another.

16. The method of claim 1, wherein said double metal cyanide (DMC) catalyst is dry-mixed with the other components.

17. The method of claim 1, wherein said double metal cyanide (DMC) catalyst is mixed as a slurry, said slurry comprising the double metal cyanide (DMC) catalyst and the monofunctional starter compound and/or solvent.

18. The method of claim 1, wherein said catalyst of formula (I) is dry-mixed with the other components.

19. The method of claim 1, wherein said catalyst of formula (I) is mixed as a solution, said solution comprising the catalyst of formula (I) and one or more of the monofunctional starter compound, epoxide and/or a solvent.

20. The method of claim 3, wherein epoxide is added in step (II).

21. The method of claim 3, wherein catalyst of formula (I) is added in step (II).

22. The method of claim 3, wherein double metal cyanide (DMC) catalyst is added in step (II).

23. The method of claim 3, wherein monofunctional starter compound is added in step (II).

24. The method of claim 3, wherein both epoxide and monofunctional starter compound are added in step (II).

25. The method of claim 3, wherein epoxide, catalyst of formula (I), double metal cyanide (DMC) catalyst and/or monofunctional starter compound is, independently, continuously added in step (II).

26. The method of claim 3, wherein epoxide, catalyst of formula (I), double metal cyanide (DMC) catalyst and/or monofunctional starter compound is, independently, discontinuously added in step (II).

27. The method of claim 1, wherein the or each monofunctional starter compound has the formula (II):
Z—RZ (II)
wherein Z can be any group which can have one —R^{Z} group attached to it;
each R^{Z} is independently selected from —OH, —NHR′, —SH, —C(O)OH, —P(O)(OR′)(OH), —PR′(O)(OH)₂ or —PR′(O)OH;
R′ is selected from H, or optionally substituted alkyl, heteroalkyl, aryl, heteroaryl, cycloalkyl or heterocycloalkyl.

28. The method of claim 1, wherein the or each monofunctional starter compound is selected from alcohols such as methanol, ethanol, 1-and 2-propanol, 1-and 2-butanol, linear or branched C₃-C₂₀-monoalcohol such as tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-decanol, 1-dodecanol, phenol, 2-hydroxybiphenyl, 3-hydroxybiphenyl, 4-hydroxybiphenyl, 2-hydroxypyridine, 3-hydroxypyridine, and 4-hydroxypyridine, mono-ethers or esters of ethylene, propylene, polyethylene; polypropylene glycols such as ethylene glycol mono-methyl ether and propylene glycol mono-methyl ether, phenols such as linear or branched C₃-C₂₀ alkyl substituted phenols, for example nonyl-phenols or octyl phenols, monofunctional carboxylic acids such as formic acid, acetic acid, propionic acid and butyric acid, fatty acids, such as stearic acid, palmitic acid, oleic acid, linoleic acid, linolenic acid, benzoic acid and acrylic acid, and monofunctional thiols such as ethanethiol, propane-1-thiol, propane-2-thiol, butane-1-thiol, 3-methylbutane-1-thiol, 2-butene-1-thiol, and thiophenol, or amines such as butylamine, tert-butylamine, pentylamine, hexylamine, aniline, aziridine, pyrrolidine, piperidine, and morpholine.

29. The method of claim 28, wherein the or each monofunctional starter compound is selected from a linear or branched C₈-C₂₀ alcohol.

30. The method of claim 1, wherein the carbon dioxide is provided continuously.

31. The method of claim 1, wherein the method is carried out at a pressure of between about 1 bar and about 60 bar carbon dioxide.

32. The method of claim 1, wherein the DMC catalyst, in addition to at least two metal centres and cyanide ligands, also comprises at least one of: one or more complexing agents, water, a metal salt and/or an acid, optionally in non-stoichiometric amounts.

33. The method of claim 1, wherein the DMC catalyst is prepared by treating a solution of a metal salt with a solution of a metal cyanide salt in the presence of at least one of: complexing agent, water, and/or an acid, optionally wherein the metal salt is of the formula M′(X′)ₚ, wherein M′ is selected from Zn(II), Ru(II), Ru(III), Fe(II), Ni(II), Mn(II), Co(II), Sn(II), Pb(II), Fe(III), Mo(IV), Mo(VI), Al(III), V(V), V(VI), Sr(II), W(IV), W(VI), Cu(II), and Cr(III),
X′ is an anion selected from halide, oxide, hydroxide, sulphate, carbonate, cyanide, oxalate, thiocyanate, isocyanate, isothiocyanate, carboxylate and nitrate,
p is an integer of 1 or more, and the charge on the anion multiplied by p satisfies the valency of M′; the metal cyanide salt is of the formula (Y)_{q}M″(CN)_{b}(A)_{c}, wherein M″ is selected from Fe(II), Fe(III), Co(II), Co(III), Cr(II), Cr(III), Mn(II), Mn(III), Ir(III), Ni(II), Rh(III), Ru(II), V(IV), and V(V),
Y is a proton or an alkali metal ion or an alkaline earth metal ion (such as K⁺),
A is an anion selected from halide, oxide, hydroxide, sulphate, cyanide oxalate, thiocyanate, isocyanate, isothiocyanate, carboxylate and nitrate;
q and b are integers of 1 or more;
c may be 0 or an integer of 1 or more;
the sum of the charges on the anions Y, CN and A multiplied by q, b and c respectively (e.g. Y×q+CN×b+A×c) satisfies the valency of M″;
the at least one complexing agent is selected from a (poly) ether, a polyether carbonate, a polycarbonate, a poly (tetramethylene ether diol), a ketone, an ester, an amide, an alcohol, a urea or a combination thereof,
optionally wherein the at least one complexing agent is selected from propylene glycol, polypropylene glycol, (m) ethoxy ethylene glycol, dimethoxyethane, tert-butyl alcohol, ethylene glycol monomethyl ether, diglyme, triglyme, methanol, ethanol, isopropyl alcohol, n-butyl alcohol, isobutyl alcohol and sec-butyl alcohol, 3-buten-1-ol, 2-methyl-3-buten-2-ol, 2-methyl-3-butyn-2-ol, 3-methyl-1-pentyn-3-ol, or a combination thereof; and
wherein the acid, if present, has the formula HᵣX″′, where X″′ is an anion selected from halide, sulfate, phosphate, borate, chlorate, carbonate, cyanide, oxalate, thiocyanate, isocyanate, isothiocyanate, carboxylate and nitrate, and r is an integer corresponding to the charge on the counterion X″′.

34. The method of claim 1, wherein the DMC catalyst comprises the formula:
M′_{d}[M″ₑ(CN)_{f}]_{g}
wherein M′ and M″ are as defined in claim 96, and d, e, f and g are integers, and are chosen to such that the DMC catalyst has electroneutrality, optionally, d is 3, e is 1, f is 6 and g is 2.

35. The method of claim 33 wherein M′ is selected from Zn(II), Fe(II), Co(II) and Ni(II).

36. The method of claim 33 wherein M″ is selected from Co(II), Co(III), Fe(II), Fe(III), Cr(III), Ir(III) and Ni(II).

37. The method of claim 1, wherein the temperature of the reaction increases during the course of the method.

38. The method of claim 1, wherein the method is carried out on an industrial scale.

39. A surfactant molecule obtainable by the method of claim 1.

40. A surfactant molecule according to claim 39 wherein the surfactant molecule has the formula (III) or (IV): 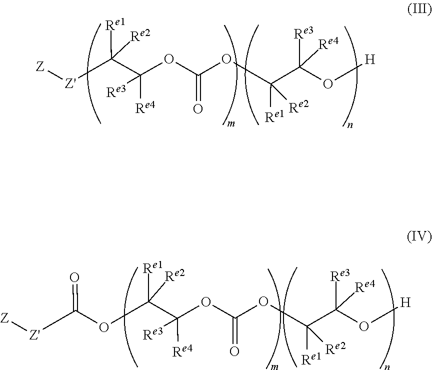
wherein each R^{e1}, R^{e2}, R^{e3} and R^{e4} is independently selected from H, halogen, hydroxyl, or optionally substituted alkyl, alkenyl, alkynyl, cycloalkyl, heterocycloalkyl, aryl, heteroaryl, heteroalkyl or heteroalkenyl or R^{e1} (or R^{e2}) and R^{e3} (or R^{e4}) may together form a saturated, partially unsaturated or unsaturated ring containing carbon and hydrogen atoms, and optionally one or more heteroatoms,
Z is any group which can have a Z′ group attached to it,
Z′ is selected from —O—, —NR′—, —S—, —C(O)O—, —P(O)(OR′)O—, —PR′(O)(O—)₂ or
—PR′(O)O— wherein R′ is selected from H, or optionally substituted alkyl, heteroalkyl, aryl, heteroaryl, cycloalkyl or heterocycloalkyl, and
n and m are integers of 1 or more.

41. The surfactant molecule of claim 40 wherein when Z′ is —O—, Z is a C₁-C₂₅ alkyl group.

42. The surfactant molecule of claim 41 wherein Z is a C₁-C₈ alkyl group.

43. The surfactant molecule of claim 41 wherein Z is a C₉-C₂₅ alkyl group.

44. (canceled)

45. A composition comprising the surfactant molecule of claim 39 wherein the composition is a surfactant formulation for a cleaning product.
